(19) United States
(12) Patent Application Publication
(10) Pub. No.: US 2025/0152978 A1
(43) Pub. Date: May 15, 2025

(54) A MASK CONFIGURED FOR PRESSURE MAINTENANCE

(71) Applicant: William Maxwell, Decatur, GA (US)

(72) Inventor: William Maxwell, Decatur, GA (US)

(21) Appl. No.: 18/835,684

(22) PCT Filed: Jan. 31, 2023
(86) PCT No.: PCT/US2023/061650

§ 371 Date: Aug. 2, 2024

Related U.S. Application Data
(60) Provisional application No. 63/321,833, filed on Mar. 21, 2022.
(60) Provisional application No. 63/306,610, filed on Feb. 4, 2022.

(51) Int. Cl. A62B 18/02; A62B 18/00; A62B 18/08

(52) U.S. Cl. CPC A62B 18/025; A62B 18/003; A62B 18/006; A62B 18/08

(57) ABSTRACT

A covering creates an air channel around a face of an entity wearing the covering. An actuable inlet includes a first conditioner. The actuable inlet regulates fluid exchange between the air channel and an outside environment. An actuable outlet includes a second conditioner. The actuable outlet regulates fluid exchange between the air channel and an outside environment. An air pressure within the air channel can be maintained at a specified level.

### TECHNICAL FIELD

This disclosure relates to maintaining pressure within a mask.

### BACKGROUND

In many professions, a personal protective equipment (PPE) mask is necessary or encouraged. For example, medical personnel within a medical facility are often required to wear surgical masks or sealed N95 masks. Other fields, such as construction, use similar protective equipment for jobs such as installing fiberglass insulation.

### SUMMARY

This specification describes technologies relating to masks used for personal protection, particularly masks that filter or otherwise condition air for a wearer. The masks disclosed herein provide advantages over conventional masks, for example, because pressure within the mask is maintained to a target pressure, which is not provided by conventional masks whether they are active or passive. For example, the pressure can be set to be substantially the same as the outside pressure, or a pressure differential can be maintained between (or adjusted) between the inside of the mask and the surrounding environment outside the mask. Managing the pressure can provide a more comfortable fit, while maintaining the effectiveness of the mask.

An example of the subject matter described within this disclosure is a mask with the following features. A covering creates an air channel around a face of an entity wearing the covering. An actuable inlet includes a first conditioner. The actuable inlet regulates fluid exchange between the air channel and an outside environment. An actuable outlet includes a second conditioner. The actuable outlet regulates fluid exchange between the air channel and an outside environment.

Aspects of the example mask, which can be combined with the example mask alone or in combination with other aspects, include the following. A pressure sensor is arranged to measure the pressure within the air channel. The pressure sensor is configured to produce a pressure stream indicative of a pressure within the air channel. A controller configured to receive the pressure stream from the pressure sensor and maintain a set pressure within the air channel responsive to the pressure stream received from the pressure sensor.

Aspects of the example mask, which can be combined with the example mask alone or in combination with other aspects, include the following. The pressure sensor is a differential pressure sensor measuring a differential pressure between the air channel and an outside environment.

Aspects of the example mask, which can be combined with the example mask alone or in combination with other aspects, include the following. The actuable inlet or actuable outlet include a variable speed fan.

Aspects of the example mask, which can be combined with the example mask alone or in combination with other aspects, include the following. In order to maintain pressure, the controller is further configured to regulate a speed of the variable speed fan.

Aspects of the example mask, which can be combined with the example mask alone or in combination with other aspects, include the following. The speed of the variable speed fan is controlled by a frequency signal sent to the variable speed fan by the controller.

Aspects of the example mask, which can be combined with the example mask alone or in combination with other aspects, include the following. The controller is further configured to calibrate the pressure sensor prior to the mask being donned by a wearer.

Aspects of the example mask, which can be combined with the example mask alone or in combination with other aspects, include the following. The first conditioner or the second conditioner includes a filter element.

An example implementation of the subject matter described within this disclosure is a method with the following features. Filtered air is received into an air channel defined by a covering and a face of an entity wearing the covering. A pressure of the filtered air within the air channel is maintained. Filtered air is expelled from the air channel.

Aspects of the example method, which can be combined with the example method alone or in combination with other aspects, include the following. Maintaining the pressure includes sensing a pressure of the air channel by a pressure sensor, regulating the sensed pressure by an actuable inlet, and regulating the sensed pressure by an actuable outlet.

Aspects of the example method, which can be combined with the example method alone or in combination with other aspects, include the following. The actuable inlet includes an inlet fan, and wherein the actuable outlet comprises an outlet fan.

Aspects of the example method, which can be combined with the example method alone or in combination with other aspects, include the following. Regulating the sensed pressure by the actuable outlet includes changing a speed of the inlet fan.

Aspects of the example method, which can be combined with the example method alone or in combination with other aspects, include the following. Regulating the sensed pressure by the actuable outlet includes changing a speed of the outlet fan.

An example implementation of the subject matter described within this disclosure is a system with the following features. A covering partially defines an air channel in conjunction with a face of an entity wearing the covering. An actuable inlet includes a first conditioner. The actuable inlet regulates fluid exchange between the air channel and an outside environment. An actuable outlet includes a second conditioner. The actuable outlet regulates fluid exchange between the air channel and an outside environment. A pressure sensor is arranged such that the pressure sensor senses a pressure within the air channel. The pressure sensor is configured to produce a pressure stream indicative of a pressure within the air channel. A controller configured to receive the pressure stream from the pressure sensor, and maintain a set pressure within the air channel responsive to the pressure stream received from the pressure sensor. A power supply is coupled to the controller.

Aspects of the example system, which can be combined with the example system alone or in combination with other aspects, include the following. The first conditioner and the second conditioner include a first filter element and a second filter element respectively.

Aspects of the example system, which can be combined with the example system alone or in combination with other aspects, include the following. The pressure sensor is a differential pressure sensor measuring a differential pressure between the air channel and an outside environment.

Aspects of the example system, which can be combined with the example system alone or in combination with other aspects, include the following. The actuable inlet includes an inlet variable speed fan and the actuable outlet comprises an outlet variable speed fan.

Aspects of the example system, which can be combined with the example system alone or in combination with other aspects, include the following. In order to maintain pressure, the controller is further configured to regulate a speed of the inlet variable speed fan and regulate a speed of the outlet variable speed fan.

Aspects of the example system, which can be combined with the example system alone or in combination with other aspects, include the following. The speed of the variable speed fan is controlled by a frequency signal sent to the variable speed fan by the controller.

Aspects of the example system, which can be combined with the example system alone or in combination with other aspects, include the following. The controller is further configured to calibrate the pressure sensor prior to the covering being donned by a wearer.

Aspects of the example system, which can be combined with the example system alone or in combination with other aspects, include the following. The set pressure is substantially the same as the outside environment.

Aspects of the example system, which can be combined with the example system alone or in combination with other aspects, include the following. The set pressure is less than that of the outside environment.

Aspects of the example system, which can be combined with the example system alone or in combination with other aspects, include the following. The system of claim 14, wherein the set pressure is greater than that of an outside environment.

Particular embodiments of the subject matter described in this specification can be implemented so as to realize one or more of the following advantages. The subject matter described herein results in a mask that is comfortable for an entity wearing the mask, for example, because pressure within the mask is maintained within a specified range. Such a mask also allows for less cross-contamination as pressure differentials between an air channel defined by the mask and the entity's face, and the outside environment, is significantly lessened or eliminated.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a perspective view of a mask that can be used with aspects of this disclosure.

FIG. 2 is a block diagram of a pressure regulating system that can be used with the example mask.

FIGS. 3A-3C are top-down cross-sectional views of an example mask during various periods of operation.

FIG. 4 is a block diagram of an example controller that can be used with aspects of this disclosure.

FIG. 5 is a flowchart of an example method that can be used with aspects of this disclosure.

Like reference numbers and designations in the various drawings indicate like elements.

### DETAILED DESCRIPTION

Personal protection equipment (PPE) masks often include a restrictive, form-fitting covering in order to protect an entity (e.g., person) wearing the PPE mask from contaminants or, in some cases, protect others from contaminants emitted from the wearing entity, such as a pathogen. Conventional passive PPE masks are considered to work best when pressed tightly against a face of an entity. Powered Air Purifying Respirators (PAPR) maintain a higher pressure inside of a mask pressed tightly against the face or a hood which encloses the entity's head. Leakage occurs due to the inherent pressure changes and/or pressure differentials that occur as the entity breaths while wearing the mask. As such, if the mask is not pressed tightly against the face, then air exhaled by the entity escapes from the sides without passing through, and being conditioned by the mask. Also, if the mask is not pressed tightly against the face, then air inhaled by the entity enters through the sides without passing through, and being conditioned by the mask. This tight fit also leads to “dead air” that the entity is forced to breath. In “passive” masks a portion of the exhale breath is retained in the mask and contributes to “dead air” being inhaled in the next breath. Such dead air is warm, humid, and uncomfortable for many entities that wear such masks. Because of the higher pressure inside PAPR, there is leakage to the outside environment, leading to possible contamination from the PAPR wearer.

This disclosure relates to a PPE mask with active ventilation that regulates, manages, and/or maintains the pressure within the mask. The mask includes an actuable inlet and an actuable outlet that allows fresh air to continually flow across an entity's face that is wearing the mask, which helps to reduce or eliminate dead air. The mask includes a conditioning element at both the actuable inlet and the actuable outlet to mitigate contaminant and pathogen concerns. The actuable inlet and outlet also adjust a pressure within the mask such that the pressure in the mask is substantially a same pressure as air outside of the mask. Such a feature allows for the mask to omit complex sealing systems to maintain a seal to the entity's face as the pressure changes caused by breathing are mitigated by the mask.

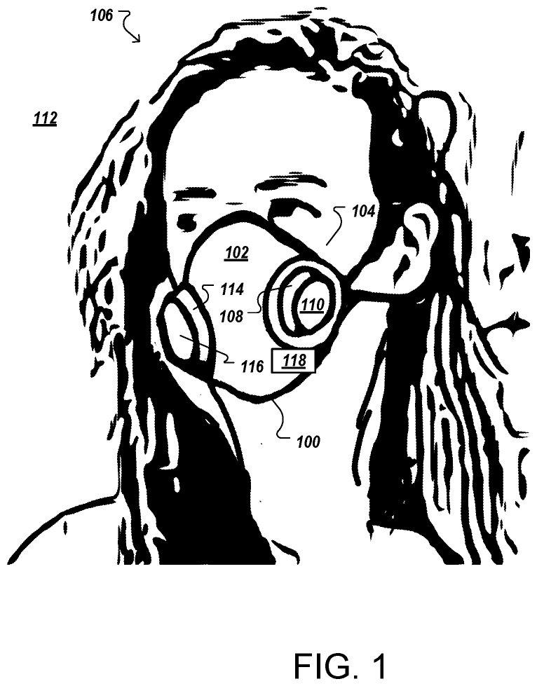

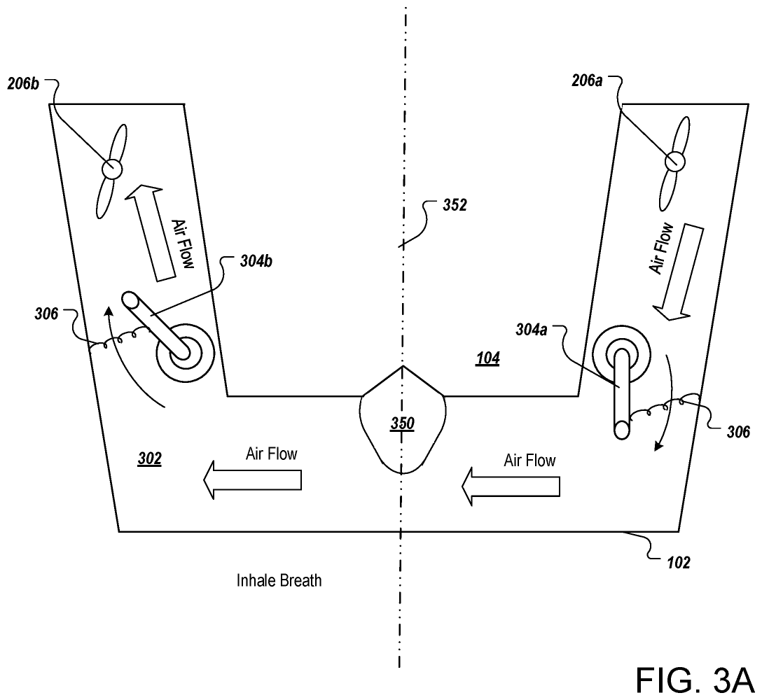

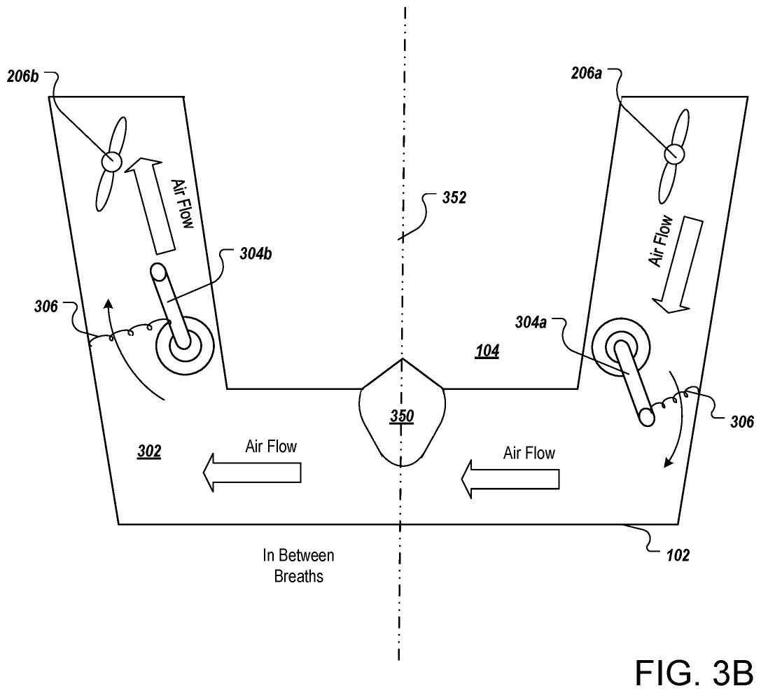

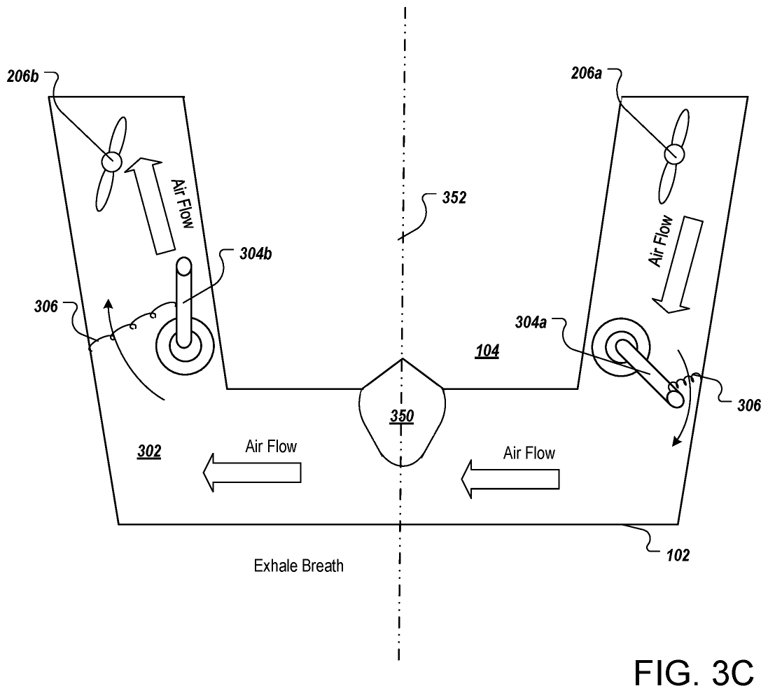

FIG. 1 is a perspective view of an example mask 100. The mask includes a covering 102 partially defining an air flow channel in conjunction with a face 104 of an entity 106 wearing the covering 102. The mask has an actuable inlet 108 with a first conditioner 110. The actuable inlet 108 regulates fluid exchange (for example, air) between the air flow channel and an outside environment 112. For example, the actuable inlet regulates air flow and exchange in some circumstances. An actuable outlet 114 has a second conditioner 116. The actuable outlet 114 regulates fluid exchange between the air channel 302 (FIG. 3) and an outside environment 112. For example, the actuable outlet regulates air flow and exchange in some circumstances. In some implementations, the actuable inlet 108 and the actuable outlet 114 are on opposite sides of the covering 102 from one another. That is, the actuable inlet 108 and the actuable outlet 114 direct fluid within the air channel across a nose and mouth of the entity 106 wearing the covering 102.

A variety of elements can be used as either the first conditioner 110 or the second conditioner 116. For example, the first conditioner 110 and the second conditioner 116 can include a high-efficiency filter element, such as an N95, KN95, or HEPA (“high efficiency particulate air) filter. In some implementations, low-efficiency filters can be used. Other conditioners can be used without departing from this disclosure. For example, chemical catalysts, UV (ultraviolet) treatments, or humidification systems can be used without departing from this disclosure.

In some implementations, a power supply 118 can be included. The power supply 118 can include a battery pack, compressed air, a super capacitor, solar cell, or any other power supply appropriate for the systems described herein. The location of the power supply 118 is only shown for purposes of example, and could be located in various places, such as in or around one of the actuable outlets, attached to a strap of the mask 100, or integrated into the covering 102 of the mask 100.

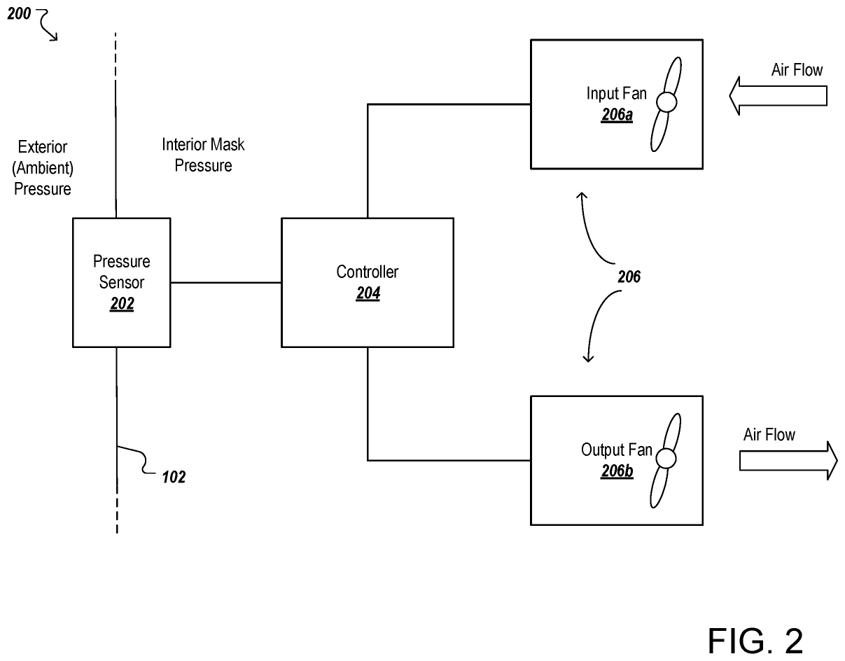

FIG. 2 is a block diagram of a pressure regulating system 200 that can be used with the example mask 100. The system 200 includes a pressure sensor 202 arranged such that the pressure sensor 202 senses, or is in fluid communication with, a pressure within the air channel 302 (FIG. 3). The pressure sensor 202 is configured to produce a pressure stream indicative of a pressure within the air passage. The pressure stream can include an analog or digital control stream. In some implementations, the pressure stream can be an electrical signal; however, other signals, such as pneumatic, hydraulic, or mechanical signals can be used without departing from this disclosure.

A controller 204 is coupled to the pressure sensor 202, the actuable inlet 108, and the actuable outlet 114, and the power supply 118. The controller 204 is configured to receive the pressure stream from the pressure sensor 202. The controller 204 is configured to maintain a set pressure within the air channel 302 responsive to the pressure stream received from the pressure sensor 202. In some implementations, the actuable inlet 108 and the actuable outlet 114 are used to set a pre-determined air flow as well.

The pressure sensor 202 can include a transducer-style sensor, or any other style pressure sensor. In some implementations, the pressure sensor 202 can include a differential pressure sensor. In implementations where a singular pressure sensor is used, that is, when a single pressure within the air channel is sensed, the controller can calibrate the sensor based on ambient air pressure prior to the entity 106 donning the mask 100. In implementations where a differential pressure sensor is used, that is, where a pressure sensor compares a pressure within the air channel to a pressure in an outside environment, the controller may not need to perform a calibration of the sensor. Rather, the controller can regulate the pressure within the air channel based on detected differences in pressure between the air channel and the outside environment.

Regardless of the type of pressure sensor 202 used, the controller 204 uses the pressure stream provided by the pressure sensor 202 to regulate pressure within the air channel. For example, in implementations where the actuable inlet 108, the actuable outlet 114, or both, include a variable speed fan 206. A speed of the variable speed fan 206 can be regulated by the controller 204 to maintain a target pressure. For example, when the entity 106 wearing the mask 100 inhales, the controller 204 can increase the speed of an inlet fan 206a to maintain the set pressure (e.g., by increasing the pressure within the mask). Alternatively or in addition, when the entity 106 wearing the mask 100 exhales, the controller 204 can increase the speed of an outlet fan 206b to maintain the set pressure (e.g., by reducing pressure within the mask). In some implementations, the controller 204 can be configured to maintain a pressure within the air channel 302 to be substantially the same as that in an outside environment 112 (plus or minus 5%). In some implementations, the controller 204 can be configured to maintain a pressure within the air channel 302 to be consistently less than that in an outside environment 112. For example, in instances where the entity 106 is contaminated, and a desire exists to prevent the entity from contaminating others. In some implementations, the controller 204 can be configured to maintain a pressure within the air channel 302 to be consistently greater than that in an outside environment 112. For example, in instances where the entity 106 is in a contaminated environment 112 (such as an infectious disease wing of a hospital), and a desire exists to prevent the entity 106 from being contaminated. In some implementations, a mechanical control system can be used.

In implementations where one or more fans 206 are used, the speed of the fans can be controlled in a variety of ways. For example, an alternating current signal can be varied in frequency to adjust the speed of each fan 206. In some implementations, such as when DC fans are used, current, voltage, or both can be actively adjusted to control fan speed. In some implementations, regardless of the fan control system used, pulse width modulation can be used by the controller 204 to control such fans.

FIGS. 3A-3C are top-down cross-sectional views of an example mask during various periods of operation. In the illustrated implementation, the inlet fan 206a is on a left side of the face 104 (right side of figure) while the outlet fan 206b is on a right side of the face 104. The covering 102 and the face 104 define the air channel 302, which extends between the inlet fan 206a and the exhaust fan 206b. In this arrangement, air flows across the nose 350 and mouth of the face 104. In some implementations, dampers 304 can be include within the air channel 302. The dampers are arranged such that they ensure or encourage a direction of air flow within the air channel, for example, from the inlet fan 206a towards the outlet fan 206b. While the illustrated implementation has an inlet fan 206a and an outlet fan 206b substantially equidistant from a centerline 352 defined by the nose 350 of the face 104, other arrangements can be used without departing from this disclosure.

In operation, as shown in FIG. 3A, the entity wearing the mask inhales. As illustrated and described, the entity inhales and exhales through a nose; however, inhaling, exhaling, or both, can also be performed through a mouth (also covered by the covering) without departing from this disclosure. As the entity 106 inhales, an inlet fan 206a accelerates to maintain pressure within the air channel 302, one or more dampers 304a,b opens to allow for greater airflow, or both. In some implementations, dampers 304a,b are used to maintain flow direction within the air channel 302. Such dampers 304a,b are arranged to allow air to flow from the inlet towards the outlet, but will seal (e.g. fully seal, partially seal, reduce flow or prevent flow) to mitigate airflow from flowing from the outlet towards the inlet. In some implementations, the dampers 304a,b include a bias 306, such as a spring or another biasing member, that biases the dampers 304a,b towards a closed position. The bias 306 is calibrated to maintain a specified pressure, flowrate, or both within the air channel 302. In some implementations, the mask 100 can include only dampers 304a,b with no fans 206. In some implementations, the mask 100 can include fans 206 with no dampers 304a,b. In some implementations, dampers 304a,b, a fan 206, and/or a bias 306 are included with the mask 100. While illustrated as flapper valves, other damper configurations can be used without departing from this disclosure, for example, a reed valve or another suitable valve.

FIG. 3B illustrates the example mask during a time between breaths. That is, between exhaling and inhaling. In such a situation, the fans 206 slow down to maintain the desired flowrate and the desired pressure within the mask. Similarly, the inlet damper 304a moves closer to the closed position as the air flow through the inlet is less than the airflow during an inhale.

FIG. 3C illustrates the example mask during an exhale. In such a situation, the outlet fan 206b speeds up to maintain the desired flowrate and the desired pressure within the mask. Similarly, the inlet damper 304a moves closer to the closed position and the outlet damper 304b moves closer to the open position (e.g., closer to a fully open position) as the air flow through the outlet is greater than the airflow through the inlet in this instance.

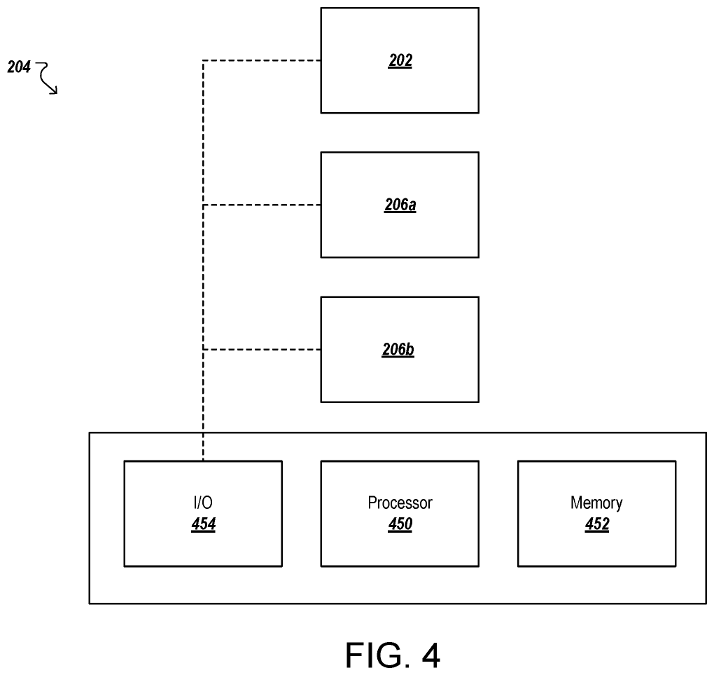

FIG. 4 is a block diagram of an example controller 204 that can be used with (e.g., to implement) aspects of this disclosure. The controller 204 can, among other things, monitor parameters of the system and send signals to actuate and/or adjust various operating parameters of the system. As shown in FIG. 4, the controller 204, in certain instances, includes a processor 450 (e.g., implemented as one processor or multiple processors) and a memory 452 (e.g., implemented as one memory or multiple memories) containing instructions that cause the processors 450 to perform operations described herein. The processors 450 are coupled to an input/output (I/O) interface 454 for sending and receiving communications with components in the system, including, for example, the sensor 202. In certain instances, the controller 204 can additionally communicate status with and send actuation and/or control signals to one or more of the various system components (including the actuable inlet 108 and actuable outlet 114) of the mask 100, as well as other sensors (e.g., pressure sensors, temperature sensors, voltage sensors, and other types of sensors) provided with the mask 100. In certain instances, the controller 204 can communicate status and send actuation and control signals to one or more of the components within the mask, such as the inlet fan 206a or the outlet fan 206b. The communications can be hard-wired, wireless, or a combination of wired and wireless. In some implementations, the controller 204 can be a distributed controller with different portions located about the mask 100 and/or the entity wearing the mask. For example, in certain instances, the controller 204 can be located at the inlet fan 206a, at the outlet fan 206b, or it can be located in a stand-alone controller box. Additional controllers can be used throughout the mask 100 as stand-alone controllers or networked controllers without departing from this disclosure.

The controller 204 can operate in monitoring, commanding, and using the mask components to maintain a pressure and/or airflow within the air channel 302. To monitor and control the mask 100, the controller 204 is used in conjunction with the sensor 202. Input and output signals, including the data from the sensor 202, controlled and monitored by the controller 204, can be logged continuously by the controller 204.

The controller 204 can have varying levels of autonomy for controlling the pressure within the air channel. For example, the controller 204 can begin sensing a pressure change, and an operator adjusts the inlet fan 206a and outlet fan 206b manually. Alternatively, the controller 204 can begin sensing a pressure change, receive an additional input from an operator (such as a “compensate” command), and begin adjusting the pressure within the air channel with no other input from an operator. Alternatively, the controller 204 can begin sensing a pressure change and adjust the inlet fan 206a and the outlet fan 206b with no input from an operator.

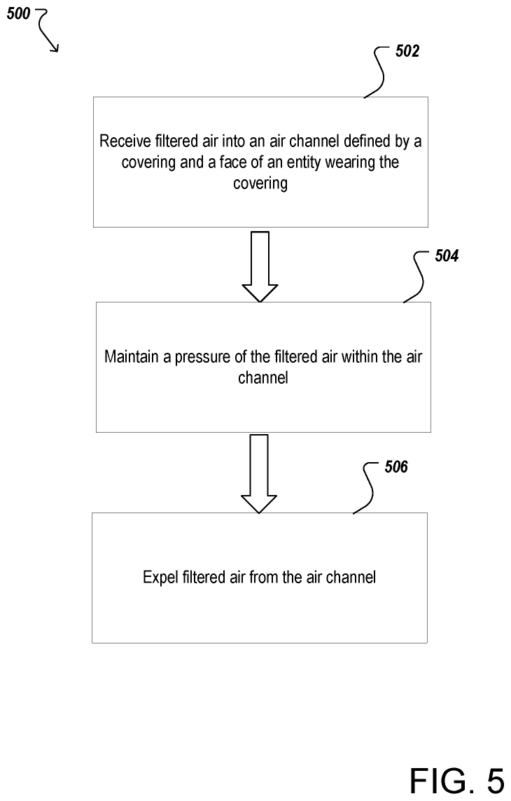

FIG. 5 is a flowchart of an example method 500 that can be used with (e.g., implemented by) aspects of this disclosure. At 502, filtered air is received into an air channel defined by a covering and a face of an entity wearing the covering. In some implementations, the filtered air is received into the air channel by a person wearing the mask inhaling, and/or an inlet fan pushing air into the air channel, as described above with reference to FIGS. 3A-3C.

At 504, a pressure of the filtered air within the air channel is maintained. In some implementations, the pressure within the air channel is maintained to be substantially a same pressure as an outside environment. In some implementations, the pressure within the air channel can be maintained to be higher or lower than the pressure of the ambient environment outside of mask (e.g., the environment surrounding the person wearing the mask). In some implementations, the pressure can be maintained in a dynamic (or programmed) fashion, for example, maintaining a first pressure during inhaling and a second pressure during exhaling.

In some implementations, maintaining the pressure of the filtered air within the air channel includes sensing a pressure of the air within the air channel by a pressure sensor. In such an implementation, the pressure of the air channel can then be regulated by an actuable inlet, an actuable outlet, or both, responsive to the sensed pressure. Such an actuable inlet, actuable outlet, or both, can include a variable speed fan. A speed of the variable speed fan can be changed to regulate the pressure, for example, as described above with reference to FIGS. 3A-3C. In implementations with both an inlet fan and an outlet fan, the inlet fan and the outlet fan can be adjusted independently of one another to maintain the pressure within the air chamber.

At 506, filtered air is expelled from the air channel. For example, an outlet fan can expel air from the air channel into a surrounding environment, as discussed above with reference to FIGS. 3A-3C.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A mask comprising:
a covering formed to create an air channel around a face of an entity wearing the covering;
an actuable inlet comprising a first conditioner, the actuable inlet regulating fluid exchange between the air channel and an outside environment; and
an actuable outlet comprising a second conditioner, the actuable outlet regulating fluid exchange between the air channel and an outside environment.

2. The mask of claim 1, further comprising:
a pressure sensor arranged to measure the pressure within the air channel, the pressure sensor configured to produce a pressure stream indicative of a pressure within the air channel; and
a controller configured to:
receive the pressure stream from the pressure sensor; and
maintain a set pressure within the air channel responsive to the pressure stream received from the pressure sensor.

3. The mask of claim 2, wherein the pressure sensor is a differential pressure sensor measuring a differential pressure between the air channel and an outside environment.

4. The mask of claim 2, wherein the actuable inlet or actuable outlet comprise a variable speed fan, and wherein the set pressure is less than the pressure of the outside environment.

5. The mask of claim 4, wherein in order to maintain pressure, the controller is further configured to:
regulate a speed of the variable speed fan.

6. The mask of claim 5, wherein the speed of the variable speed fan is controlled by a frequency signal sent to the variable speed fan by the controller.

7. The mask of claim 2, wherein the controller is further configured to:
calibrate the pressure sensor prior to the mask being donned by a wearer.

8. The mask of claim 1, wherein the first conditioner or the second conditioner comprises a filter element.

9. A method comprising:
receiving filtered air into an air channel defined by a covering and a face of an entity wearing the covering;
maintaining a pressure of the filtered air within the air channel; and
expelling filtered air from the air channel.

10. The method of claim 9, wherein maintaining the pressure comprises:
sensing a pressure of the air channel by a pressure sensor;
regulating the sensed pressure by an actuable inlet; and
regulating the sensed pressure by an actuable outlet.

11. The method of claim 10, wherein the actuable inlet comprises an inlet fan, and wherein the actuable outlet comprises an outlet fan.

12. The method of claim 11, wherein regulating the sensed pressure by the actuable outlet comprises changing a speed of the inlet fan.

13. The method of claim 11, wherein regulating the sensed pressure by the actuable outlet comprises changing a speed of the outlet fan.

14. A system comprising:
a covering partially defining an air channel in conjunction with a face of an entity wearing the covering;
an actuable inlet comprising a first conditioner, the actuable inlet regulating fluid exchange between the air channel and an outside environment;
an actuable outlet comprising a second conditioner, the actuable outlet regulating fluid exchange between the air channel and an outside environment;
a pressure sensor arranged such that the pressure sensor senses a pressure within the air channel, the pressure sensor configured to produce a pressure stream indicative of a pressure within the air channel;
a controller configured to:
receive the pressure stream from the pressure sensor; and
maintain a set pressure within the air channel responsive to the pressure stream received from the pressure sensor; and
a power supply coupled to the controller.

15. The system of claim 14, wherein the first conditioner and the second conditioner comprise a first filter element and a second filter element respectively.

16. The system of claim 14, wherein the pressure sensor is a differential pressure sensor measuring a differential pressure between the air channel and an outside environment.

17. The system of claim 14, wherein the actuable inlet comprises an inlet variable speed fan and the actuable outlet comprises an outlet variable speed fan.

18. The system of claim 17, wherein in order to maintain pressure, the controller is further configured to:
regulate a speed of the inlet variable speed fan; and
regulate a speed of the outlet variable speed fan.

19. The system of claim 18, wherein the speed of the variable speed fan is controlled by a frequency signal sent to the variable speed fan by the controller.

20. The system of claim 14, wherein the controller is further configured to:
calibrate the pressure sensor prior to the covering being donned by a wearer.

21. The system of claim 14, wherein the set pressure is substantially the same as the outside environment.

22. The system of claim 14, wherein the set pressure is less than that of the outside environment.

23. The system of claim 14, wherein the set pressure is greater than that of an outside environment.
